(19) United States
(12) Patent Application Publication
(10) Pub. No.: US 2009/0010809 A1
(43) Pub. Date: Jan. 8, 2009

(54) MANUAL PIPETTE FILLER

(76) Inventors: Peter T. Hadjis, Vernon Hills, IL (US); Christopher J. Stvartak, Skokie, IL (US); Michael Reedy, Chicago, IL (US); Tong Jin Kim, Evanston, IL (US)

Correspondence Address: MICHAEL BEST & FRIEDRICH LLP, Two Prudential Plaza, 180 North Stetson Avenue, Suite 2000, CHICAGO, IL, 60601, US

(21) Appl. No.: 11/772,905

(22) Filed: Jul. 3, 2007

(51) Int. Cl. B01L 3/02

(52) U.S. Cl. 422/100

(57) ABSTRACT

A pipette device for aspirating and dispensing liquid, the pipette device comprising: a housing including a handgrip portion; and a bulb contained within the handgrip portion of the housing, the bulb compressible by a user to facilitate aspirating and dispensing of liquid.

### BACKGROUND

The present invention relates to a laboratory device, and in particular, to a manual pipette device for aspirating and dispensing liquids.

Persons performing low-impact, repetitive tasks such as word processing sometimes report pain and/or discomfort in the hands, arms, and neck. Doctors now diagnose such debilitating pain and discomfort as carpal tunnel syndrome or other cumulative trauma disorder (CTD), or repetitive stress injury (RSI). Ergonomic disorders, such as the aforementioned, have spawned a multi-billion dollar industry intending to maximize worker productivity by providing comfortable workstations, chairs, and computer hardware, thereby minimizing fatigue and discomfort.

Despite the advances of ergonomics for the office environment, in a laboratory setting, such as a medical laboratory, laboratory technicians are still subjected to repetitive operations with sub-optimal ergonomic devices, such as pipette devices. Pipetting is the act of aspirating and dispensing controlled volumes of liquid, and is one of the most frequently performed repetitive lab operations. Attempts to minimize the occurrences of RSIs in the lab have focused on training technicians in body mechanics (e.g., posture, pipetting technique, etc.), and providing an ergonomic pipette device. Further, in a laboratory setting, a technician may need to pipette with one hand while performing another function with the other hand, such as entering or recording date.

The design of a pipette device is as important as the manner in which it is used. Pipette manufacturers recognize the benefits of an ergonomic pipette device, as is evidenced by the number of different ergonomic devices available. For example, many devices include a contoured handgrip to allow for a relaxed hold on the device. However, many of these products cannot be operated with one-hand and require either two-handed operation, changing hands, moving the device, and/or shifting a user's grip on the device during aspirating and dispensing. Such maneuvers result in inefficiencies, wasted time and accidents within the work environment.

### SUMMARY

In one embodiment, the invention provides a pipette device for aspirating and dispensing liquid. The pipette device includes a housing having a handgrip portion, and a bulb contained within the handgrip portion of the housing. The bulb is compressible by a user to facilitate aspirating and dispensing of liquid

In another embodiment, the invention provides a pipette device for aspirating and dispensing liquid. The pipette device includes a housing, a handgrip portion defined by the housing, a trigger movably coupled to the handgrip portion, and a bulb between the handgrip portion and the trigger. The bulb is compressible by moving one of the trigger and the handgrip portion toward the other.

In yet another embodiment, the invention provides a pipette device for aspirating and dispensing liquid. The pipette device includes a housing, a trigger movably coupled to the housing and a bulb between the trigger and the housing. The pipette device also includes a controller movably coupled to the housing for facilitating aspiring and dispensing of liquid. The trigger and controller are located so as to permit one-handed operation of the trigger and the controller.

Other aspects of the invention will become apparent by consideration of the detailed description and accompanying drawings.

### BRIEF DESCRIPTION OF THE DRAWINGS

FIG. 1 is a side elevation view of a pipette device according to one embodiment of the invention.

FIG. 2 is an exploded view of the pipette device shown in FIG. 1.

FIG. 3 is a perspective view of the partially assembled pipette device illustrating a bulb and trigger configuration for the device.

FIG. 4 is a perspective view of a partially assembled pipette device according to another embodiment of the invention.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

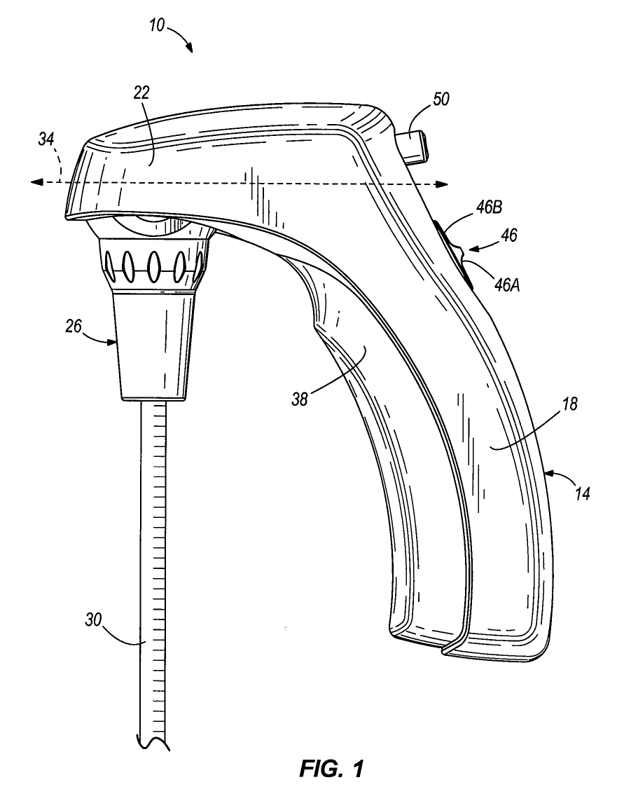

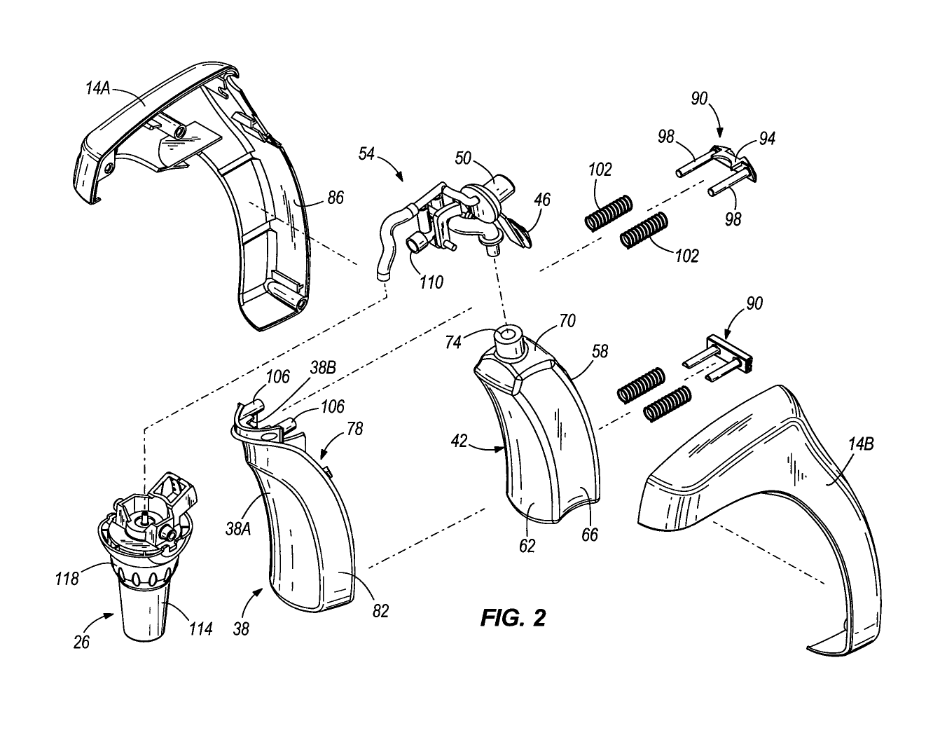

Referring to FIG. 1, one embodiment of a manual pipette device 10 is shown. In the illustrated embodiment, the pipette device 10 includes a generally pistol-shaped housing 14, although other shapes are suitable for the housing 14. The pipette device allows for one-handed operation; therefore, it is not necessary for a user to move the device, change the position of his/her grip, or change hands in order to create a vacuum force within the device 10 and aspirate and dispense liquid into a pipette 30. The housing 14 may be constructed of any suitable material known in the art, but in one embodiment the housing 14 is constructed of a plastic material molded or otherwise formed into two halves 14A, 14B (FIG. 2) that are secured together by fasteners, such as screws (not shown). In one embodiment, the housing 14 includes an external matte finish that provides a non-slip surface for improved gripping and handling of the pipette device 10.

The housing 14 includes a handgrip portion 18, a barrel portion 22, and a nozzle assembly 26 for receiving a pipette 30. To those of skill in the art, such pipette devices are referred to as pipetting aids or pipette guns. During typical use of the device, the barrel portion 22 is oriented substantially parallel with a work surface (e.g., table, benchtop, etc.). In this way, a device axis 34 is defined through the pipette device 10, which is generally horizontal during typical use, but may be oriented otherwise for a user's comfort. The nozzle assembly 26 is operable to releasably retain glass and plastic pipettes 30 of various sizes and volumes. In one embodiment, the nozzle assembly 26 may be pivoted away from the handgrip portion 18 to reduce arm strain during pipetting. Advantageously, the handgrip portion 18 is ergonomically designed to reduce hand strain and is hand-neutral (i.e., usable by both right-handed and left-handed users).

A trigger 38 having a shape contoured to the handgrip portion 18 projects through a portion of the handgrip portion 18. The trigger 38 is positioned for actuation by a user's fingers and includes an ergonomic treatment, such as a curved, concave, or contoured end surface, for reducing finger fatigue. A user squeezes the trigger 38 into the handgrip portion 18 to expel air, thereby creating a vacuum force within a bulb 42 of the pipette device 10 that facilitates aspirating and dispensing of controlled volumes of liquid.

A controller 46 (e.g., a lever) and a blowout button 50 are located on the handgrip portion 18 of the housing 14 and are used to aspirate and dispense liquid. The controller 46 is positioned on the handgrip portion 18 of the housing 14 opposite of the trigger 38. The controller 46 includes two surfaces 46A, 46B having an ergonomic treatment, such as a curved, concave or contoured face, for reducing finger fatigue. The controller 46 is movable by a user's thumb as a user's hand grips the handgrip portion 18. In the illustrated embodiment, movement of the controller 46 towards the barrel portion 22 of the housing aspirates fluid into the pipette 30 and movement of the controller 46 away from the barrel portion 22 dispenses fluid from the pipette 30; however, the movement of the controller 46 towards and away from the barrel portion 22 may alternatively dispense and aspirate fluid, respectively.

The blowout button 50 is positioned on the handgrip portion 18 adjacent the barrel portion 22 of the housing. The button 50 also includes an ergonomic treatment for increasing user comfort. The button 50 is positioned for pressing by a user's thumb while the user's hand grips the handgrip portion 18. In the illustrated embodiment, pressing the button 50 expels the last remaining liquid in the pipette 30. That is, after the pipette 30 has been emptied of liquid to a great extent by gravity, the button 50 expels the last few drops of liquid remaining in the pipette 30.

Referring to FIG. 2, the pipette device 10 includes the bulb 42 and an air valve system 54 contained within the housing 14. The bulb 42 is positioned within the handgrip portion 18 of the housing 14 and has a contoured shape to fit within the two halves 14A, 14B of the housing 14. In the illustrated embodiment, the bulb 42 includes an outwardly extending, curved or convex rearward wall 58; an inwardly extending, curved or concave forward wall 62; opposed, inwardly extending, curved or concave side walls 66 (only one side wall is shown in FIG. 2), a lower wall (not shown), and an upper wall 70. The walls 58-70 define a bulb interior for containing air. A port 74 formed in the upper wall 70 of the bulb 42 provides a fluid connection between the bulb 42 and the air valve system 54.

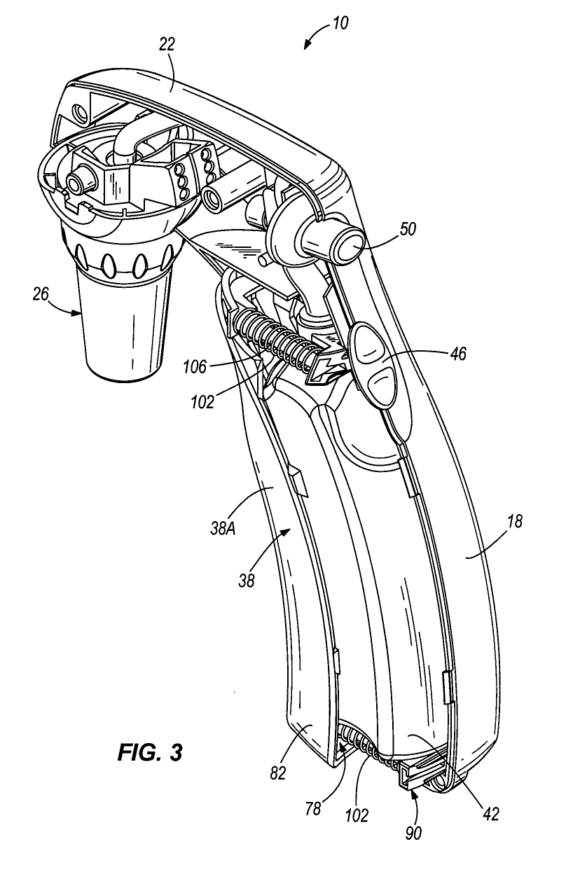

The bulb 42 may be constructed of any suitable resilient or elastic material known in the art, but preferably the bulb 42 is constructed of a rubber material molded or otherwise formed into the bulb 42. The concave side walls 66 of the bulb 42 allow the bulb 42 to collapse smoothly as the bulb 42 is compressed by the trigger 38 to expel air from the bulb 42. The bulb material should be thick enough to spring back to an uncompressed shape (FIGS. 2 and 3). The bulb walls 58-70 are semi-rigid and tend to spring to the uncompressed shape, which facilitates the introduction of air back into the interior of the bulb 42.

As shown in FIGS. 2 and 3, the trigger 38 includes an outer surface 38A defining a grip portion for a user and an inner surface 38B defining an interior compartment 78. Side walls 82 of the trigger 38 extend between the outer surface 38A and the inner surface 38B. When assembled, the side walls 82 of the trigger are positioned between the bulb 42 and an inner surface 86 of the handgrip portion 18 such that a portion of the bulb 42 is received within the interior compartment 78 of the trigger 38. When a user squeezes the handgrip portion 18 of the pipette device 10, the trigger 38 slides into the handgrip portion 18 and towards the bulb 42. The trigger 38 presses into the bulb 42 to compress the bulb 42. Air is forced out of the bulb 42 through the port 74 to the air valve system 54.

Two slide members 90 positioned within the housing 14 define a slide path for the trigger 38. In the illustrated embodiment, the slide members 90 are coupled to the inner surface 86 of the handgrip portion 18 of the housing 14. Each slide member 90 includes a base portion 94 coupled to the housing 14, and two projections 98 extending from the base portion 94 and toward the trigger 38. A spring 102 extends between each projection 98 of the slide member 90 and the trigger 38 to bias the trigger 38 away from the bulb 42 to an initial, resting position (FIGS. 1 and 3). One end of the spring 102 is supported by the respective projection 98 and an opposite end of the spring 102 is supported by the trigger 38. For example, the spring 102 may be supported by a boss 106 extending from the inner surface of the trigger 38.

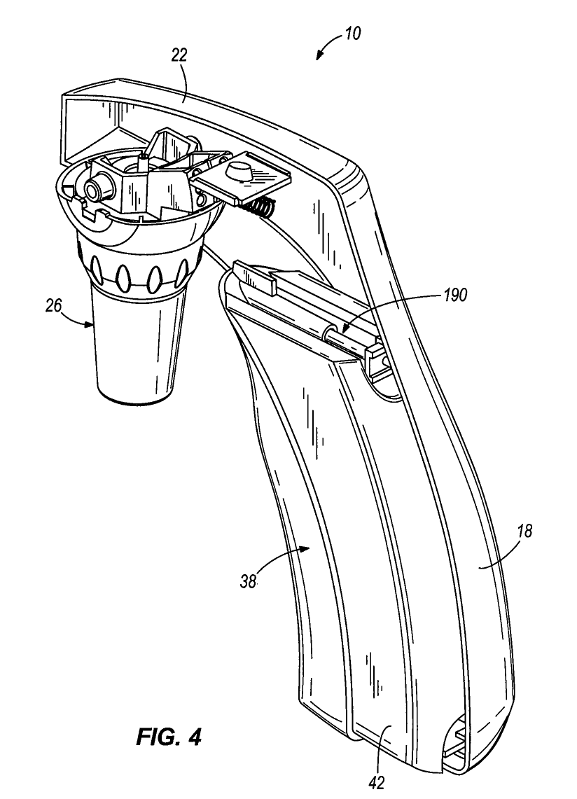

When the trigger 38 is pressed into the bulb 42, the spring bias is overcome to compress the bulb 42. Once a user releases the trigger 38, the spring biases the trigger 38 away from the bulb 42 to the resting position. In one embodiment, the bulb 42 remains in a compressed shape until air is reintroduced to the interior of the bulb 42; however, in another embodiment, the bulb 42 returns to the initial, uncompressed shape. It should be readily apparent to those of skill in the art that in further embodiments, fewer or more slide members 90 may be used in the pipette device 10 and that each slide member 90 may include fewer or more springs 102 and/or projections 98. For example, the pipette device 10 shown in FIG. 4 includes a pair of single projection slide members 190 to facilitate movement of the trigger 38.

The air valve system 54 regulates air pressure within the bulb 42 and the flow of liquid to and from the pipette 30, as is known in the art. The air valve system 54 is fluidly connected to the bulb 42 at one end via the port 74 and to the nozzle assembly 22 at an opposite end. The air valve system 54 also includes an outlet (not shown) for expelling air from the bulb 42 and the air valve system 54 when the bulb 42 is squeezed, and an inlet 110 to let outside air into the air valve system 54. Although not shown in FIG. 2, the air valve system 54 includes a valve interconnected to the controller 46 for regulating aspiration of liquid into the pipette 30 and dispensing liquid from the pipette 30, as is known in the art. It should be readily apparent to those of skill in the art that any known air valve system for pipette devices may be used in the present invention to aspirate and dispense liquid to and from the pipette.

Referring to FIGS. 1 and 2, the nozzle assembly 26 includes a nozzle housing 114 having a generally frustoconical shape and central bore (not shown) therethrough. The exterior of the nozzle assembly 26 may include gripping detents 118 that facilitate disassembly of the nozzle assembly 26 for filter replacement, cleaning, autoclaving, or the like. One example of the nozzle assembly 26 used with the pipette device is disclosed in U.S. patent application Ser. No. 10/759,358, entitled “Pipette Device with Pivotable Nozzle Assembly”, filed Jan. 16, 2004 and assigned to Heathrow Scientific LLC, which is incorporated herein by reference. In the illustrated embodiment, the nozzle assembly 26 includes a pivot mechanism (not shown) to selectively pivot the nozzle assembly 26 away from the handgrip portion 18 to reduce arm strain during pipetting. It should be readily apparent to those of skill in the art that in further embodiments other known nozzle assemblies may be used with the pipette device 10.

The trigger 38 and the bulb 42 described above facilitate one-handed operation of the pipette device 10. A user grips the handgrip portion 18 of the pipette device 10, with either a left hand or right hand, and is able to perform all functions to aspirate and dispense liquid with one hand. During use, the user squeezes the handgrip portion 18 by pressing the trigger 38 towards the bulb 42, which causes the trigger 38 to compress the bulb 42 and force air within the bulb 42 out through the air valve system 54, thereby creating a vacuum force within the bulb 42. After the bulb 42 is emptied, the operator relaxes the grip on the trigger 38 to allow the trigger 38 to bias back to the resting position.

In the illustrated embodiment, to aspirate the pipette 30, the user moves the controller 46 toward the barrel portion 22. The air valve system 54 fills the bulb vacuum with air from the pipette 30 attached to the nozzle assembly 26 and pulls liquid into the pipette 30. To dispense liquid from the filled pipette 30, the user moves the controller 46 away from the barrel portion 22 of the housing 14, and the air valve system 54 allows air to enter the air valve system 54 through the inlet 110. The outside air dispenses liquid from the pipette 30. To expel the last portion of liquid in the pipette 30, the user pushes the blowout button 50 to push air through the air valve system 54 and dispense the remaining liquid from the pipette 30.

Depending on the pipette capacity, the bulb capacity and the number of pipettes being filled, the bulb 42 may completely refill with air, thereby losing the vacuum force, before a pipette is full. In these circumstances, the user presses the trigger 38 again to compress the bulb 42 and create a vacuum force within the bulb 42 without removing the pipette 30. For example, in on embodiment the bulb has a capacity of 60 mL and the user is working with 25 mL pipettes. The compressed bulb is capable of filling two 25 mL pipettes and drawing only 10 mL into a third pipette. The user compresses the bulb again to expel air from the bulb and create a vacuum force, and is therefore able to continue filling the pipette to its full capacity.

The pipette device 10 allows for one-handed operation, which results in more efficiency and reduction in laboratory accidents. It is not necessary for the user to move the device 10, change the position of his/her grip, or change hands in order to create vacuum force that facilitates aspiration of liquid into the pipette 30. One-handed operation is particularly helpful when a bulb 42 becomes completely filled with air prior to a pipette 30 being filled by allowing the user to compress the bulb 42 again without moving the device or changing the position of his/her grip on the handgrip portion 18.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

What is claimed is:

1. A pipette device for aspirating and dispensing liquid, the pipette device comprising:
a housing including a handgrip portion; and
a bulb contained within the handgrip portion of the housing, the bulb compressible by a user to facilitate aspirating and dispensing liquid.

2. The pipette device of claim 1, and further comprising a trigger movably coupled to the handgrip portion, the trigger adapted to compress the bulb.

3. The pipette device of claim 2 wherein the bulb is between the trigger and the handgrip portion.

4. The pipette device of claim 1 wherein the bulb includes concave side walls.

5. The pipette device of claim 1 wherein the bulb is configured to collapse as the bulb is compressed.

6. A pipette device for aspirating and dispensing liquid, the pipette device comprising:
a housing;
a handgrip portion defined by the housing;
a trigger movably coupled to the handgrip portion; and
a bulb between the handgrip portion and the trigger, the bulb compressible by moving one of the trigger and the handgrip portion toward the other.

7. The pipette device of claim 6 wherein the trigger is slidably received by the handgrip portion.

8. The pipette device of claim 7 wherein the trigger compresses the bulb as the trigger is slidably received by the handgrip portion.

9. The pipette device of claim 7, and further comprising a slide member within the housing, the slide member defining a slide path for the trigger.

10. The pipette device of claim 7 wherein the trigger includes side walls between the bulb and an inner surface of the handgrip portion.

11. The pipette device of claim 6 wherein the trigger defines an interior compartment for receiving part of the bulb.

12. The pipette device of claim 6 wherein the trigger has a contoured shape substantially similar to a shape of the handgrip portion.

13. The pipette device of claim 6 wherein the trigger is biased to a first position and movable to a second position to compress the bulb.

14. A pipette device for aspirating and dispensing liquid, the pipette device comprising:
a housing;
a trigger movably connected to the housing;
a bulb between the trigger and the housing;
a controller movably coupled to the housing for facilitating aspiring and dispensing of liquid, wherein the trigger and controller are located so as to permit one-handed operation of the trigger and the controller.

15. The pipette device of claim 14, and further comprising an air valve system within the housing, the air valve system configured for aspiring and dispensing of liquid.

16. The pipette device of claim 15 wherein the controller regulates the air valve system.

17. The pipette device of claim 15, and further comprising a blowout button for expelling air from the air valve system, the blowout button positioned sufficiently close to the trigger and the controller to permit one-handed operation of the blowout button, the trigger and the controller.

18. The pipette device of claim 15 wherein the bulb is connected to the air valve system.

19. The pipette device of claim 14 wherein the controller includes a lever movable in a first direction to draw liquid into the pipette and movable in a second direction to dispense liquid from the pipette.
